(19) United States
(12) Patent Application Publication
(10) Pub. No.: US 2005/0274689 A1
(43) Pub. Date: Dec. 15, 2005

(54) Printed wiring board, production process thereof and semiconductor device

(75) Inventors: Ken Sakata, Tokyo (JP); Hiromu Terada, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: MITSUI MINING & SMELTING CO., LTD.

(21) Appl. No.: 11/124,822

(22) Filed: May 9, 2005

(30) Foreign Application Priority Data
May 10, 2004 (JP) 2004-139972

(51) Int. Cl. H01B 13/00

(52) U.S. Cl. 216/13; 438/51; 174/262; 174/250

(57) ABSTRACT

A printed wiring board comprising an insulating film, a wiring pattern formed on at least one surface of the insulating film, a metal plating layer on the wiring pattern, and a resin protective layer provided on the wiring pattern with the metal plating layer in between so as to expose terminal portions of the wiring pattern plated with the metal, wherein the metal plating layer on the wiring pattern has a surface roughness (Rz) of 1.1 μm or above. A semiconductor device includes the printed wiring board and an electronic component mounted thereon. In production of the printed wiring board, the wiring pattern is surface roughened prior to forming the metal plating layer such that the metal plating layer formed thereon will have a surface roughness (Rz) of 1.1 μm or above. The surface roughening treatment of the wiring pattern reduces problems such as foaming in the resin protective layer by thermal shock even when the metal plating layer is made of a low-activity metal such as gold.

### FIELD OF THE INVENTION

The present invention relates to a printed wiring board in which a resin protective layer is hardly separated or foamed by thermal shock by heat in the mounting of an electronic component. The present invention also relates to a production process of the printed wiring board and a semiconductor device using the printed wiring board. More particularly, the present invention is concerned with a printed wiring board in which a wiring pattern is plated with a low-surface-activity layer such as a noble metal wherein a resin protective layer provided uppermost is hardly separated or foamed by thermal shock by heat in the mounting of an electronic component. The present invention is also concerned with a production process and a semiconductor device of the printed wiring board.

### BACKGROUND OF THE INVENTION

Printed wiring boards are used for integration of electronic components in an electronic equipment. There are a variety of printed wiring boards, with examples including those in which a substrate film is composed of an insulating film at least one surface of which is coated with a conductive metal layer such as a copper layer, the conductive metal layer is selectively etched to form a desired wiring pattern, the wiring pattern is plated with such a metal as tin, and the metal-plated wiring pattern is covered with a resin protective layer so as to expose terminal portions.

In such printed wiring boards in which the metal plating layer is formed on the surface of the wiring pattern, the bond strength of the resin protective layer that is provided so as to cover the metal plating layer is greatly dependent on the surface condition of the plating. In particular, with recent reduction of wire width and pitch of wiring patterns, the adhesion of the resin protective layer is more dependent on the surface condition of the metal plating layer on the wiring pattern than on the surface condition of the insulating film. Particularly, the adhesion of the resin protective layer is greatly dependent on the surface condition of the metal plating layer on the wiring pattern when the resin protective layer is provided by attaching a dry resin protective sheet. In the case where the metal plating layer contains a noble metal, the adhesion of the resin protective layer tends to be further lowered due to low activity of the metal of which the plating is made.

When an electronic component is mounted on the printed wiring board, the printed wiring board is heated to establish electrical connection between electrodes of the electronic component and leads of the printed wiring board. If the resin protective layer has low adhesion, the layer is often foamed or separated due to thermal shock by the heating. The printed wiring board in which the resin protective layer has been foamed or separated is defective and cannot be used.

Meanwhile, to improve the adhesion between copper and a resin, Patent Document 1 (JP-A-2002-47583) discloses a method of etching a copper or copper alloy surface with an etching agent including sulfuric acid, hydrogen peroxide, phenyltetrazole and a chlorine source. Further, Patent Document 2 (JP-A-H11-29883) discloses an etching solution including sulfuric acid, hydrogen peroxide and tetrazole (or a tetrazole derivative).

According to these patent documents, microetching a copper or copper alloy surface with the above etching solution roughens the copper surface to provide improved adhesion between the copper surface and a solder resist layer applied thereon. It is also described that the microetching with the etching solution etches the copper surface by about 1.5 μm.

The above patent documents disclose the adhesion of the solder resist layer formed directly on the microetched copper surface, but do not provide any description about the adhesion between the resin protective layer and the metal plating layer formed on the microetched copper surface. When a wiring pattern is formed by selective etching, the wiring pattern formed is conventionally subjected to microetching for the purpose of removing the metal oxide on the surface of wiring pattern or roughening the wiring pattern surface. In general, a solder resist layer is provided directly on the wiring pattern, and the above microetching is performed to improve the adhesion of the solder resist layer with the wiring pattern. However, the above patent documents do not describe that a metal plating layer is formed on the wiring pattern and the resin protective layer is provided through the metal plating layer, and do not disclose how to control the surface condition of the wiring pattern being a base for the metal plating layer. The patent documents only disclose a microetching method for producing projections and depressions to enhance the bond strength with an interlayer resin in a multilayer board. This is because the conventional printed wiring boards have large pitches between wiring patterns, and the adhesion of the solder resist layer is dominantly determined by the adhesion with an insulating substrate such as a polyimide film. Even if the adhesion between the wiring pattern and the solder resist layer is low, the solder resist layer is firmly bonded with the insulating film. That is, even if the bond strength between the wiring pattern and the solder resist layer is rather low, this partial low bond strength is not a problem from the viewpoint of adhesion of the solder resist layer as a whole.

In some printed wiring boards, the wiring pattern is plated with a metal for protection of the wiring pattern before the resin protective layer such as solder resist layer is provided. The resin protective layer, which is provided on the metal plating layer, does not exhibit sufficient bond strength when the metal of the metal plating layer has a low activity. Particularly, the solder resist layers in recent years are often provided by attaching a resin protective film of desired shape to form a resin protective layer, as well as application of a solder resist ink. In the former case, sufficient bond strength is often not exhibited between the resin protective film and the metal plating layer.

When the metal plating layer is formed on the wiring pattern, the bond strength of the resin protective film or the like with the metal plating layer varies greatly depending on the activity of the metal of the metal plating layer. If the metal of the metal plating layer on the wiring pattern has a low activity, for example gold, attachment of the resin protective film on the inactive metal plating layer cannot achieve sufficiently high bond strength. Therefore, there is a growing possibility that thermal shock in the mounting of an electronic component will result in foams in the resin protective film.

There is no known method capable of solving the attachment problems such as foaming by thermal shock in a resin protective film.
Patent Document 1: JP-A-2002-47583
Patent Document 2: JP-A-H11-29883

### SUMMARY OF THE INVENTION

The present invention has objects of providing a printed wiring board in which a metal plating layer is formed on the entire surface of a wiring pattern wherein the printed wiring board has a reduced possibility of problems such as foaming by thermal shock in a resin protective layer, and also providing a production process thereof and a semiconductor device including the printed wiring board.

A printed wiring board according to the present invention comprises an insulating film, a wiring pattern formed on at least one surface of the insulating film, a metal plating layer on the wiring pattern, and a resin protective layer provided on the wiring pattern with the metal plating layer in between so as to expose terminal portions of the wiring pattern plated with the metal, wherein the metal plating layer on the wiring pattern has a surface roughness (Rz) of 1.1 μm or above.

A process for producing a printed wiring board according to the present invention comprises selectively etching a substrate film comprising an insulating film and a metal layer on at least one surface of the insulating film to form a wiring pattern, roughening the wiring pattern such that a metal plating layer formed on the wiring pattern has a surface roughness (Rz) of 1.1 μm or above, forming a metal plating layer on the wiring pattern, and providing a resin protective layer on the metal plating layer on the wiring pattern so as to expose terminal portions.

Superior properties of the printed wiring board of the present invention are more distinguished when the metal plating layer on the entire surface of the wiring pattern contains an inactive noble metal, especially gold.

In the printed wiring board according to the present invention, a wiring pattern plated with a metal is formed on at least one surface of an insulating film, and a resin protective layer is provided on the wiring pattern with the metal plating layer in between. The wiring pattern is surface conditioned such that the metal plating layer formed thereon has a surface roughness. (Rz) of 1.1 μm or above. Therefore, the resin protective layer on the wiring pattern through the metal plating layer resists foaming even when thermal shock is applied in the mounting of an electronic component, and the wiring pattern, metal plating layer and resin protective layer are firmly united together. In general, when a dry resin protective film is attached to a gold plating layer in particular to provide a resin protective layer, the resin protective film will have low adhesion and thermal shock will cause foams. The present invention enables remarkable reduction of problems in such cases attributable to the foaming of the resin protective film.

### BRIEF DESCRIPTION OF THE DRAWINGS

FIG. 1 is a schematic view of a printed wiring board according to the present invention;

FIG. 2 is a schematic sectional view taken along the line A-A in the printed wiring board of FIG. 1;

FIG. 3 is a schematic perspective view of a resin protective film used to provide a resin protective layer in the present invention; and

FIG. 4 is a set of microscope pictures showing surfaces of surface-roughened wiring patterns and those of gold plating layers on the wiring patterns of the printed wiring boards of the present invention; wherein:
11 . . . Insulating film
12 . . . Sprocket hole
13 . . . Device hole
14 . . . Wiring pattern
15 . . . Input outer lead
16 . . . Input inner lead
17 . . . Output inner lead
18 . . . Output outer lead
19 . . . Metal plating layer
20 . . . Resin protective layer
21 . . . Resin protective sheet
23 . . . Perforation corresponding to device hole
25 . . . Adhesive layer
26 . . . Resin layer

### DETAILED DESCRIPTION OF THE INVENTION

The printed wiring board, production process, and semiconductor device in which an electronic component is mounted on the printed wiring board will be described in detail with reference to the drawings.

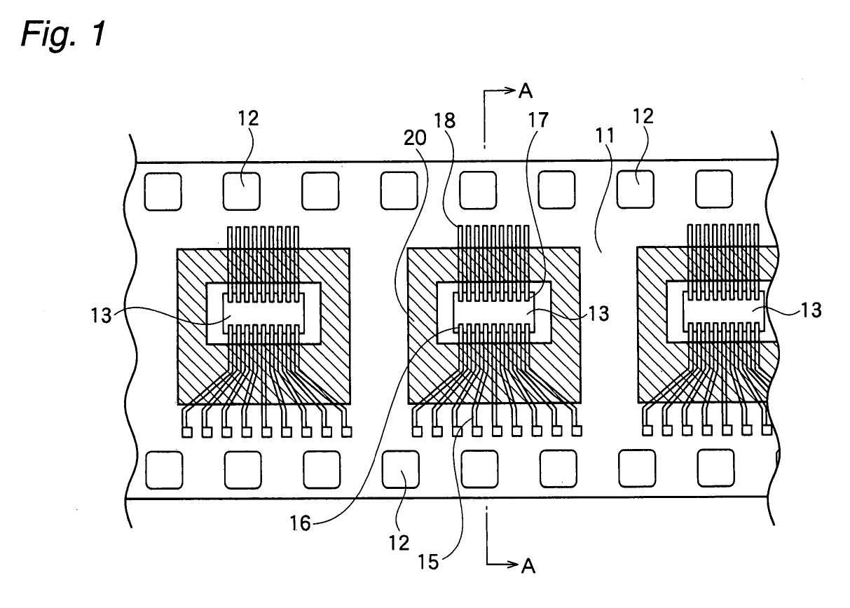

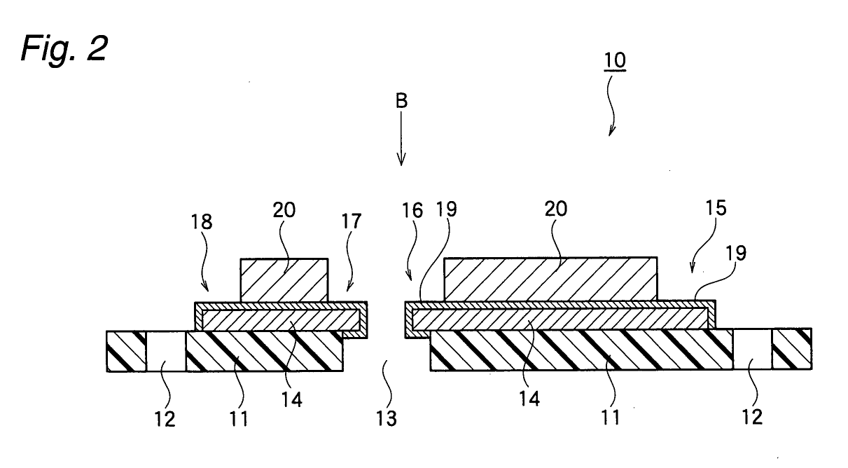

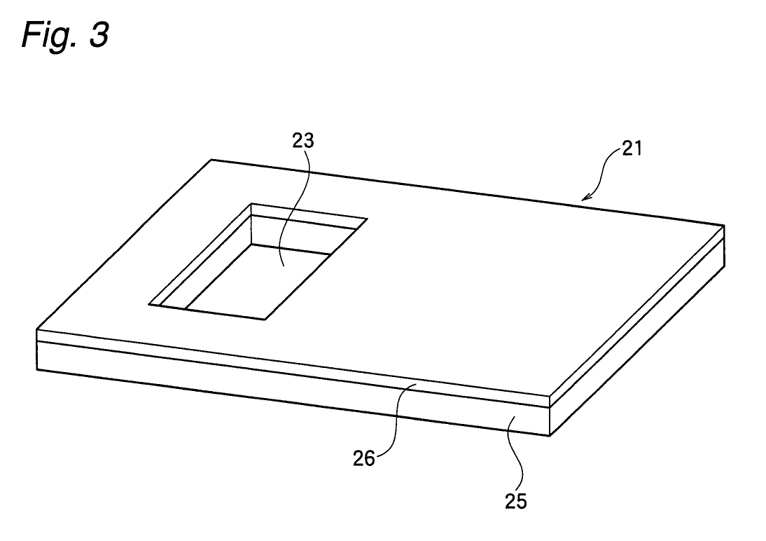

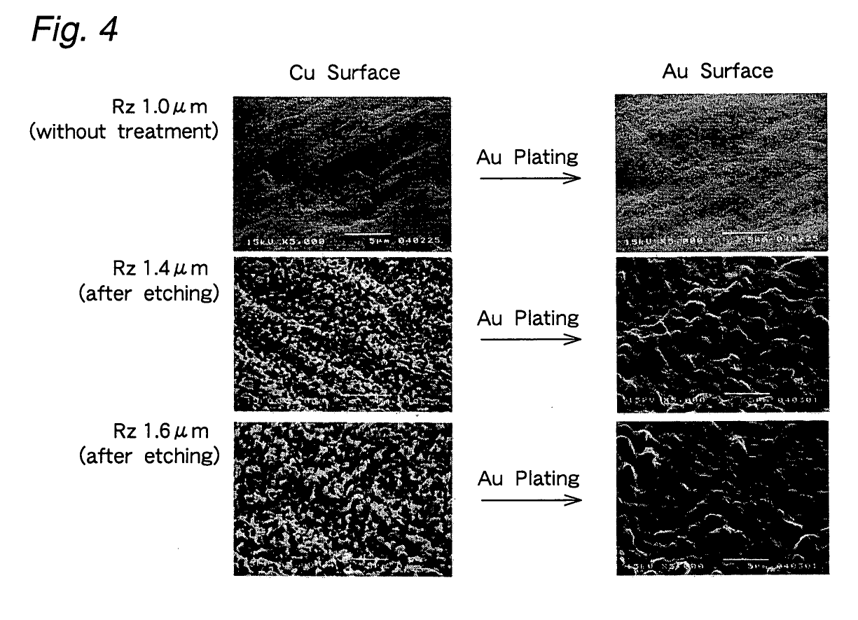

FIG. 1 is a schematic view of a flexible TAB tape, which is one example of the printed wiring board of the present invention. FIG. 2 is a schematic sectional view taken along the line A-A of FIG. 1. FIG. 3 is a schematic perspective view of a dry resin protective film to be attached on the wiring pattern to provide a resin protective layer.

In the printed wiring board of the present invention, a wiring pattern is provided. The wiring pattern is formed by processes in which a substrate film comprising an insulating film and a metal layer formed on at least one surface of the insulating film is selectively etched to selectively dissolve the metal layer. In FIGS. 1 and 2, the insulating film and the wiring pattern are indicated with the numerals 11 and 14, respectively.

The insulating films 11 employable in the present invention include polyimide films, polyimideamide films, polyester films, polyphenylene sulfide films, polyetherimide films, fluororesin films and liquid crystal polymer films. Specifically, the insulating films 11 have acid and alkali resistance such that they will not be corroded by an etching solution used in etching or an alkaline solution used in the washing. Further, the insulating films possess heat resistance such that heat distortion is avoided when the film is heated in the mounting of an electronic component. Polyimide films are preferable insulating film 11 having such characteristics.

The insulating film 11 generally has an average thickness of 5 to 150 μm, preferably 5 to 125 μm, and particularly preferably 25 to 75 μm.

The insulating film 11 may be provided with device holes 13 in which an electronic component is mounted, or may be provided with sprocket holes 12 in the vicinity of edges in the width direction as means for transportation and positioning. Other through-holes such as positioning holes or output slits may be formed as required.

In the printed wiring board of the present invention, the device holes are not compulsory because the mounting of electronic components is feasible without the device holes. Also, the sprocket holes for transportation may be omitted because roll transportation permits transportation without the sprocket holes.

The insulating film has a conductive metal layer on at least one surface thereof. That is, the printed wiring board of the present invention will have a wiring pattern on one surface or both surfaces of the insulating film. FIGS. 1 and 2 illustrate an embodiment in which the insulating film 11 has a wiring pattern 14 on one surface thereof.

The metals of the conductive metal layer of the present invention include such conductive metals as copper, copper alloys and aluminum. Particularly, the present invention preferably employs a copper foil as the conductive metal layer. The copper foils used herein include rolled copper foils and electrodeposited copper foils.

The conductive metal foil generally has a thickness in the range of 2 to 70 μm, preferably 8 to 35 μm, although it depends on the objective linewidth of the wiring pattern 14. When the objective linewidth of the wiring pattern is small, a thin conductive metal foil will be used. The conductive metal foil may be laminated directly on the insulating film 11, or may be attached through an adhesive layer (not shown) When it is necessary that the conductive metal layer has to be an extremely small thickness, the conductive metal will be deposited directly on the insulating film by vapor deposition or sputtering.

After the conductive metal layer is formed on the insulating film 11 as described above, a photosensitive resin is applied on the conductive metal layer and the photosensitive resin layer is exposed and developed to produce a resin pattern.

The thus-formed resin pattern is used as a mask, and the conductive metal layer is selectively etched to form a desired wiring pattern 14. The printed wiring board of the present invention has particularly high usability when the wiring patterns have the smallest wiring pitches in the range of 20 to 80 μm (namely, the wiring width from 10 to 40 μm and the wiring interval from 10 to 40 μm).

The etching agent used in the present invention may be a conventional one. When the conductive metal layer is a copper layer, an etching solution, which contains hydrochloric acid, and cupric chloride or ferric chloride may be used. Selectively etching of the conductive metal layer using the resin pattern as a mask produces a wiring pattern 14 similar in shape to the resin pattern used. After formation of the wiring pattern 14, the resin pattern is removed by alkali washing or the like.

When the conductive metal layer is an electrodeposited copper foil, the wiring pattern produced as described above has a surface in which copper is electrically deposited to provide a shiny surface (electrode side surface). This surface of the wiring pattern is very smooth, and the surface roughness of the wiring pattern corresponds to that of the shiny surface of electrodeposited copper foil. The surface roughness (Rz) is generally in the range of 0.5 to 2.5 μm, and most often 0.5 to 1.5 μm. When a metal plating layer is formed on the wiring pattern with such a very smooth surface, the smoothness of the metal plating surface tends to increase. Accordingly, if the above-produced wiring pattern is directly plated with the metal, the metal plating layer formed will have a surface roughness (Rz) of less than 1.1 μm. With such surface smoothness comparable to a mirror surface, adequate bond strength cannot be exhibited between the wiring pattern and the resin protective layer. The rolled copper foils generally have a surface roughness (Rz) of 0.5 to 1.0 μm.

Accordingly, in the present invention, the wiring pattern 14 formed as above is controlled to be surface roughened such that the metal plating treatment of the wiring pattern will produce a metal plating layer having a surface roughness (Rz) of 1.1 μm or above, preferably in the range of 1.1 to 2.0 μm, and particularly preferably 1.3 to 1.8 μm.

In the present invention, the surface roughness (Rz) is measured using SURFTEST SV-3000 (manufactured by Mitutoyo Corporation) under conditions in which a tracer has a tip radius of 1 μm, arbitrary 10 points are measured, and the 8 values excluding the minimum and maximum data values are averaged to determine the surface roughness.

Electron microscopic observation of the wiring pattern in which the surface roughness (Rz) is controlled as above confirms that the surface is roughened more than indicated by differences in surface roughness (Rz).

The etching agent used herein may be an etching solution which is based on an inorganic acid such as sulfuric acid, and optionally contains an oxidizing agent such as hydrogen peroxide and an additive that provides etching properties enabling the surface roughening of the wiring pattern. That is, an etching agent capable of highly uniform etching performance as used in uniformly etching a copper foil to produce a wiring pattern cannot be used as the etching solution for surface roughening of the wiring pattern. Even when such etching agent is used, a desired effect will not be achieved.

The etching agent will be suitably an etching solution capable of surface roughening the wiring pattern in a selective manner. Such etching agents include surface etching agents for conductive metals, particularly copper, that are based on inorganic acids such as sulfuric acid and oxidizing agents such as hydrogen peroxide and contain heterocyclic compounds having at least one element of nitrogen, oxygen and sulfur, and further contain auxiliaries which supply chlorine ions. While the above etching agents contain hydrogen peroxide as the oxidizing agent, the hydrogen peroxide may be replaced with air or oxygen that is blown into the etching solution. The etching agents for the surface roughening treatment should be balanced in elution and protection performance on the etched conductive metal surface. That is, the conductive metal of the wiring pattern surface that has been contacted with the etching agent should be protected from the etching agent to avoid overetching, and the conductive metal newly exposed on the wiring pattern surface should be eluted and be prevented from excessive elution. For this reason, a heterocyclic compound containing at least one element of nitrogen, oxygen and sulfur is added in the etching agent to coordinate to and protect the conductive metal surface etched by the principal ingredients of the etching solution. The heterocyclic compounds include those containing a nitrogen, a sulfur or an oxygen atom. Specific examples include thiazole, benzothiazole, benzotriazole, mercaptobenzotriazole, carboxybenzotriazole, phenoxytetrazole, guanamine, guanine, indole, skatole, pyridines, pyrimidines, thiobarbituric acid, guanidines and pyrroles.

The chlorine ion sources for use in the etching agent include inorganic chlorides such as potassium chloride.

In production of the printed wiring board of the present invention, the selectively etched wiring pattern is preferably surface roughened with use of the above surface-roughening etching solution to a surface roughness (Rz) of at least 1.1 μm, more preferably 1.1 to 2.0 μm, and still preferably 1.3 to 1.8 μm. Specifically, to produce the printed wiring board, a conductive metal foil is selectively etched to form a wiring pattern, a metal plating layer 19 is formed on the wiring pattern 14, and a resin protective layer 20 is provided on the metal plating layer 19 so as to expose terminal portions 15, 16, 17 and 18. If the metal plating layer 19 has too smooth surface, the surface and the resin protective layer 20 do not have adequate bond strength, so that forms are caused by thermal shock in the mounting of an electronic component. In general, a wiring pattern 14 that is surface conditioned as described above is directly provided with a resin protective layer such as a solder resist layer. In the printed wiring board of the present invention, the surface conditioned wiring pattern is plated with a metal to form a metal plating layer 19. It is conventional practice that prior to providing a resin protective layer, the wiring pattern surface is covered with a plating of a metal (for example, tin) poorer than the wiring pattern metal (for example, copper) to prevent occurrence of scoops (pitting corrosion) in the wiring pattern. When such anti-corrosion plating is formed, however, surface roughening of the wiring pattern prior to the plating is generally not performed.

The present invention achieves high usability when the surface roughened wiring pattern is plated with a metal nobler than the metal of the wiring pattern. When the metal plating layer contains a noble metal, higher usability is obtained. Further, particularly high usability is achieved when the metal of the metal plating layer has low activity as when the metal plating layer is a gold plating layer. It is very difficult to roughen the surface of such metal plating layer by chemical processes. Moreover, physical surface roughening treatment of the metal plating layer is also difficult because of small width and thickness of the wiring pattern.

Thus, in the present invention, the wiring pattern is made of a conductive metal such as copper that can be roughened more easily than a metal plating layer containing a noble metal such as gold, so that the wiring pattern is surface roughened to a predetermined surface roughness, and thereafter the metal plating layer is formed on the roughened surface of the wiring pattern. As a result, the wiring pattern, metal plating layer and resin protective layer are united together more strongly.

In the printed wiring board of the present invention, the surface roughness (Rz) of the wiring pattern 14 is controlled generally in the range of 1.1 μm or above, preferably 1.1 to 2.0 μm, and more preferably 1.3 to 1.8 μm. The metal plating layer 19 formed on the wiring pattern 14 can have a surface condition such that the resin protective layer 20 possesses bond strength resistant to foaming by thermal shock.

Although the surface roughness (Rz) of the wiring pattern exceeding 2.0 μm provides a sufficient bond strength of the resin protective layer 20, the termina portions 16, 17, 18 and 19 also have an increased surface roughness (Rz) to result in problems in the printed wiring boards and semiconductor devices in which electronic components are mounted as described below. That is, when an electronic component is mounted on the input and output inner leads 16 and 17 in a direction indicated by an arrow B in FIG. 2, bump electrodes (not shown) of the electronic component and the surface metal of the inner leads 16 and 17 form an excess amount of eutectic alloy. When the wiring patterns 14 are arranged at small pitch widths, the excess amount of eutectic alloy possibly causes a short circuit between neighboring wiring patterns.

In the surface roughening of the wiring pattern of the printed wiring board, surface roughening conditions are manipulated so as to achieve the above surface roughness (Rz) of the wiring pattern 14. For example, the etching solution based on sulfuric acid and hydrogen peroxide is generally temperature controlled in the range of 20 to 50° C., and the wiring pattern is contacted with the etching solution having the temperature for 5 to 60 seconds. Since the etching solution reduces its surface roughening capability with passage of service time, management of the etching solution requires careful attention. In the present invention, the contact time of the etching solution with the wiring pattern is a time from the first contact of the etching solution with the wiring pattern to the completion of washing of the etching solution. Various methods are employable to contact the etching solution with the wiring pattern. For example, the etching solution may be sprayed through nozzles to the insulating film on which the wiring patterns are formed. Alternatively, the insulating film on which the wiring patterns are formed may be immersed in a surface roughening treatment bath filled with the etching solution.

It is necessary that the wiring pattern is uniformly contacted with the etching solution. For example, when the etching solution is sprayed, the spraying will be performed so as to spray the etching solution uniformly to the wiring pattern by oscillating the spraying nozzles. It is also desirable that the etching solution is prevented from stagnating on the insulating film during surface roughening.

After the completion of the contact with the etching solution, the surface roughened wiring pattern is quickly washed with water to remove the etching solution, otherwise the etching solution attached to the wiring pattern will continue the surface roughening reaction.

In the present invention, the surface roughening treatment is followed by formation of the metal plating layer 19 on the wiring pattern. The metal plating layer may be a tin plating layer, a solder plating layer, a lead-free solder plating layer or a nickel plating layer. In particular, the metal plating layer preferably contains a metal nobler than the metal of the wiring pattern, especially a noble metal. The noble metals for forming the metal plating layer include gold, palladium and silver. In particular, the metal plating layer is preferably a gold plating layer. The gold plating may be a pure gold plating, or may contain other metals without deteriorating the characteristics of the gold plating layer. The gold plating layer is generally a single-layer plating, however a metal plating layer of other than gold may be formed under the gold plating layer without deteriorating the characteristics of the gold plating layer.

In the printed wiring board of the present invention, the metal plating layer 19 is formed on the entire surface of the surface roughened wiring pattern 14. That is, the metal plating layer 19 is formed so as to cover the entire of the wiring pattern 14 prior to providing the resin protective layer such as resin protective film. The metal plating layer may be formed by various methods, including wet plating processes such as electroplating and electroless plating, and dry plating processes such as vapor deposition and sputtering.

The metal plating layer, for example a gold plating layer generally has an average thickness of 0.05 to 1.5 μm, and preferably 0.1 to 1.0 μm.

The metal plating layer 19 having this average thickness tends to have a surface roughness equal to or slightly lower than the surface roughness (Rz) of the surface roughened wiring pattern 14. As shown in FIG. 4, the surface roughened wiring pattern possesses a surface having many very fine projections and depressions. In the metal plating treatment, projections including very fine projections and depressions are entirely covered with the metal plating layer to form projections having a larger size, and depressions including very fine projections and depressions are entirely covered with the metal plating layer to form depressions having a larger size. That is, the fine projections and depressions are covered substantially entirely with the metal plating layer to form projections and depressions having a larger size. When the metal plating layer with larger-sized projections and depressions is provided with a resin protective film as the resin protective layer, an adhesive layer of the resin protective film favorably spreads into the projections and depressions. As a result, the metal plating layer and the resin protective film are united with a very high bond strength, so that problems such as foams by thermal shock are unlikely to occur between the metal plating layer and the adhesive layer of the resin protective film.

FIG. 4 compares the surface conditions of surface roughened wiring patterns with the surface conditions of metal plating layers on the wiring patterns. The figure shows that the metal plating layer covers fine projections and depressions, and that projections and depressions become more distinct after the plating. However, measurement of the surface roughness (Rz) reveals that the surface roughness (Rz) does not differ widely before and after formation of the metal plating layer. The difference, if any, is not more than 20%, and most often not more than 15% of the surface roughness (Rz) of the surface roughened wiring pattern. That is, the formation of the metal plating layer does not affect much the surface roughness (Rz), and the surface is smoothed only slightly.

The uppermost pictures of FIG. 4 show surface conditions of an unetched wiring pattern and a metal plating layer (gold plating layer) formed thereon. Because of no surface roughening treatment, the wiring pattern surface does not have fine projections and depressions. The gold plating layer formed on the wiring pattern shows a further smoother surface.

The middle pictures show surface conditions of a wiring pattern and a gold plating layer, in which the wiring pattern is roughened to a surface roughness (Rz) of 1.5 μm, and the gold plating layer formed thereon has a surface roughness (Rz) of 1.4 μm. As shown, fine projections and depressions are covered with the gold plating to form projections and depressions in a larger size.

The lowermost pictures show similar surface conditions of a wiring pattern and a gold plating layer, in which the gold plating layer has a surface roughness (Rz) of 1.6 μm.

It is necessary that the metal plating layer on the surface roughened wiring pattern has a surface roughness (Rz) of 1.1 μm or above, preferably in the range of 1.1 to 2.0 μm, and more preferably 1.3 to 1.8 μm. The metal plating layer having this surface roughness permits the resin protective layer, especially an adhesive layer of a resin protective film, to have remarkably improved adhesion with the metal plating layer. Accordingly, the adhesion between the two can be maintained firmly even when they are heated in the mounting of an electronic component, and the resin protective film can be prevented from separation due to foaming or the like.

As shown in the electron microscope pictures of FIG. 4, the surface condition of the wiring pattern visibly changes before and after formation of the metal plating layer, but the surface roughness (Rz) does not differ greatly. This is probably explained as follows: The surface roughness (Rz) is an average of values measured in many points (for example, ten points) using a tracer having a tip radius (R) of about 1 μm, and minor structure changes are homogenized by arithmetic averaging. Another probable reason is that depressions smaller than the tracer's tip radius (R) are difficult to detect.

However, it is for certain that the surface roughening of the wiring pattern provides an apparently different surface condition and the metal plating layer formed thereon possesses a surface condition that is visibly different from that of the surface roughened wiring pattern.

The surface conditions provided by forming the metal plating layer, for example those shown in FIG. 4, permit visibly improved adhesive strength of the resin protective film, leading to greatly enhanced thermal shock resistance of the resin protective film.

In the present invention, the metal plating layer formed on the entire surface of the wiring pattern is provided with the resin protective layer 20 so as to expose the terminal portions 16, 17, 18 and 19.

The resin protective layer 20 may be provided by selective application of a solder resist ink with screen printing technology as conventional. Alternatively, as illustrated in FIG. 3, a resin film 26 with an adhesive layer 25 on one surface thereof may be beforehand shaped as desired to prepare a resin protective sheet 21, and the resin protective sheet 21 may be applied. In FIG. 3, the numeral 23 indicates a part corresponding to the device hole 13 in the printed wiring board.

The resin protective sheet 21 for use in the present invention is preferably a resin film that has good heat resistance and flexibility comparable to that of the insulating film 11 (or insulating resin substrate). Such resin films include polyamide films, aramid resin films and polyimide films. The resin film 26 generally ranges in average thickness from 5 to 50 μm, and preferably from 8 to 40 μm. The adhesive layer 25 for bonding the resin film 26 is preferably insulating and made of an adhesive that exhibits fluidity when heated such that the adhesive layer can spread in between wires of the wiring pattern 14. Also, the adhesive is preferably a thermosetting adhesive that effects bonding by being cured with heat. Such adhesives include epoxy resin adhesives, urethane resin adhesives, polyimide adhesives, thermosetting acrylic adhesives and phenolic adhesives.

The adhesive layer 25 of the above adhesive desirably has an average thickness that is equal to or slightly larger than the height of the wiring pattern on the insulating film, i.e., the thickness of the conductive metal foil of the wiring pattern. Generally, the adhesive layer 25 is formed such that its average thickness will be 1.0 to 2.0 times, preferably 1.05 to 1.3 times the average thickness of the conductive metal foil.

The use of the resin protective sheet 21 permits simplification of a step of providing the resin protective layer 20. Further, the nonuse of a solder resist ink eliminates the possibility of bleeding and the need of long-term curing. Accordingly, the printed wiring board can be produced efficiently.

However, because the resin protective sheet 21 is bonded through the adhesive layer 25, the bond strength is greatly dependent on the condition of the metal plating layer 19 on the wiring pattern surface. Particularly, when the metal plating layer 19 is made of a noble metal such as gold, the low activity of the metal causes remarkably deteriorated bond strength of the resin protective layer 20 composed of the resin protective sheet 21. Thus, the thermal shock in the mounting of an electronic component often causes foams in the resin protective layer 20. The printed wiring board of the present invention solves this problem as follows. The wiring pattern is surface roughened as described above and the metal plating 19 layer is formed on the roughened wiring pattern such that the adhesive layer will favorably spread when the resin protective film is attached. The adhesive layer 25 is heated to exhibit fluidity and spreads into the projections and depressions on the metal plating layer 19. The adhesive layer 25 and the projections and depressions of the metal plating layer 19 engage with each other, so that the metal plating layer 19 and the resin film 26 are strongly bonded. In particular, when the metal plating layer 19 is a gold plating layer or a gold-containing noble metal plating layer, the bond strength of the resin protective sheet can be 3 times or more, and most often 5 times or more the bond strength obtained when the wiring pattern is plated without the surface roughening.

Moreover, the resin protective layer 20 composed of the resin protective sheet 21 is hardly foamed by heat (thermal shock) applied in the mounting of an electronic component.

Foaming by thermal shock is a problem that is encountered not only with the resin protective sheet but also when the resin protective layer 20 is produced from a solder resist ink.

As described above, the wiring pattern 14 is surface roughened and the metal plating layer 19 is formed thereon, and the resin protective layer 20 is provided on the metal plating layer 19. This achieves significant increase of bond strength of the resin protective layer 20 and reduces the possibility of foaming by thermal shock. Accordingly, the temperature in the mounting of an electronic component can be set high to permit reduction of the mounting time, which leads to lessen thermal shock applied to the electronic component. Accordingly, defective electronic components caused by the mounting can be prevented.

After the resin protective layer 20 is formed as described above, the terminal portions 16, 17, 18 and 19 exposed from the resin protective layer 20 may be further plated as required.

The above-described printed wiring board of the present invention can be used similarly to conventional printed wiring boards.

Applications of the printed wiring board of the present invention include printed wiring boards (PWB), flexible printed circuit (FPC) boards, flexible long tape automated bonding (TAB) tapes, chip on film (COF) tapes, chip size package (CSP) tapes, ball grid array (BGA) tapes, μ-ball grid array (μ-BGA) tapes and printer TAB tapes.

The printed wiring board, in which the wiring pattern is formed on the insulating film, can be fabricated into a semiconductor device by mounting an electronic component on the terminal portions of the wiring pattern, followed by resin sealing.

The above semiconductor device of the present invention, similarly to the printed wiring board, does not suffer foams in the resin protective layer by thermal shock, and has excellent heat resistance and very high reliability.

### EXAMPLES

The present invention will be hereinafter described in greater detail by Examples, but it should be construed that the invention is in no way limited to those Examples.

### Example 1

A polyimide film of 50 μm in average thickness (UPILEX-S (trade name), available from UBE INDUSTRIES, LTD.), having an adhesive layer on one surface, was perforated by punching to produce sprocket holes and device holes.

The polyimide film was bonded with thermo-compression with an electrodeposited copper foil of 35 μm in nominal thickness to produce a substrate film. The surface of the electrodeposited copper foil on which the polyimide film was bonded was a matte surface (roughend surface) with a surface roughness (Rz) of 5 μm. Therefore, the substrate film had a shiny surface with a surface roughness (Rz) of 1.0 μm.

A photosensitive resin was applied on the surface (shiny surface) of the electrodeposited copper foil of the substrate film, and the resin was exposed and developed to form a desired pattern.

Subsequently, the substrate film was immersed in an etching solution containing cupric chloride and the electrodeposited copper foil was selectively etched using the pattern as a mask, so that wiring patterns similar in shape to the mask were formed at wiring pitches of 80 μm (wiring width: 40 μm, wiring interval: 40 μm). The wiring pattern retained to some extent the surface roughness (Rz) of the shiny surface of the electrodeposited copper foil. The surface roughness (Rz) was 1.3 μm. After the wiring pattern had been formed as described above, the resin pattern mask was removed using alkaline wash water.

Subsequently, the surface of the wiring pattern was roughened with use of an etching solution that was based on sulfuric acid and hydrogen peroxide and contained potassium chloride as chlorine ion source and a benzotriazole compound. The roughening treatment of the wiring pattern resulted in a surface roughness (Rz) of 1.5 μm. The surface roughness was measured with SURFTEST SV-3000 (manufactured by Mitutoyo Corporation) fitted with a tracer having a tip radius (R) of 1 μm.

In the roughening treatment, the etching solution was sprayed through a plurality of nozzles to the film such that the wiring pattern would be uniformly contacted with the etching solution.

The etching device used herein was adjacent to a water washing device, and the tape discharged from the etching device was subjected to a washing step.

The wiring patterns of the thus-washed tape were plated with gold. The gold plating layer had an average thickness of 0.7 μm and a surface roughness (Rz) of 1.4 μm. The surface of the gold plating layer is shown in an electron microscope picture of FIG. 4.

Separately, a resin film with an adhesive was prepared in which an epoxy resin adhesive layer of 35 μm in average thickness was formed on one surface of a 12 μm-thick polyimide film. To produce a resin protective sheet, the resin film with an adhesive was perforated such that terminal portions of the wiring pattern would be exposed.

The resin protective sheet perforated as above was placed on the wiring pattern, and they were bonded with thermo-compression at 200° C. to fabricate a printed wiring board.

The printed wiring board was tested to determine the bond strength of the resin protective sheet bonded, resulting in 420 g/cm.

Further, the mounting of an electronic component was simulated by heating the printed wiring board at 260° C. and 370° C. to apply thermal shock, but no problems such as foams were caused in the resin protective film.

### Example 2

A printed wiring board was produced in the same manner as in Example 1, except that the etching conditions were changed such that the gold plating layer on the wiring pattern had a surface roughness (Rz) of 1.6 μm.

The printed wiring board was tested to determine the bond strength of the resin protective sheet bonded, resulting in 430 g/cm.

Further, the mounting of an electronic component was simulated by heating the printed wiring board at 260° C. and 370° C. to apply thermal shock, but no problems such as foams were caused in the resin protective film.

### Comparative Example 1

A printed wiring board was produced in the same manner as in Example 1, except that the surface roughening treatment of the wiring pattern was not performed. The surface roughness (Rz) of the wiring pattern was 1.3 μm, the same as that of the shiny surface of the electrodeposited copper foil used. The surface roughness (Rz) of the gold plating layer was 1.0 μm.

The printed wiring board was tested to determine the bond strength of the resin protective sheet bonded, resulting in 67 g/cm.

Further, the mounting of an electronic component was simulated by heating the printed wiring board at 260° C. and 370° C. to apply thermal shock. At 260° C., no foams were caused in the resin protective film, but many foams occurred at 370° C.

The above results are collectively shown in Table 1.

TABLE 1

| | | Ex. 1 | Ex. 2 | Comp. Ex. 1 |
|---|---|---|---|---|
| Surface | | 1.4 μm | 1.6 μm | 1.0 μm |
| roughness | | | | |
| (Rz) | | | | |
| Bond | (g/cm) | 420 | 430 | 67 |
| strength | | | | |
| Foaming by | 260° C. | No | No | No |
| thermal | 370° C. | No | No | Yes |
| shock | | | | |

In the printed wiring board and semiconductor device according to the present invention, the wiring pattern is surface roughened such that the metal plating layer formed on the wiring pattern has a surface roughness (Rz) of 1.1 μm or above, and the resin protective layer is provided on the surface roughened wiring pattern. Accordingly, the resin protective layer exhibits extremely high bond strength, and high reliability is achieved with little possibility of problems such as foaming in the resin protective layer by heat in the mounting of an electronic component. Further, the process of the present invention enables easy production of the highly reliable printed wiring board.

1. A printed wiring board comprising an insulating film, a wiring pattern formed on at least one surface of the insulating film, a metal plating layer on the wiring pattern, and a resin protective layer provided on the wiring pattern with the metal plating layer in between so as to expose terminal portions of the wiring pattern plated with the metal, wherein the metal plating layer on the wiring pattern has a surface roughness (Rz) of 1.1 μm or above.

2. The printed wiring board according to claim 1, wherein the metal plating layer is formed on the entire surface of the wiring pattern.

3. The printed wiring board according to claim 1, wherein the metal plating layer on the wiring pattern contains a noble metal.

4. The printed wiring board according to claim 3, wherein the metal plating layer containing a noble metal is a gold plating layer.

5. The printed wiring board according to claim 1, wherein the metal plating layer on the wiring pattern has a surface roughness (Rz) in the range of 1.1 to 2.0 μm.

6. The printed wiring board according to claim 1, wherein the resin protective layer is a solder resist layer applied on the wiring pattern through the metal plating layer or a resin protective film attached to the wiring pattern through the metal plating layer.

7. A process for producing a printed wiring board, which process comprises selectively etching a substrate film comprising an insulating film and a metal layer on at least one surface of the insulating film to form a wiring pattern, roughening the wiring pattern such that a metal plating layer formed on the wiring pattern has a surface roughness (Rz) of 1.1 μm or above, forming a metal plating layer on the wiring pattern, and providing a resin protective layer on the metal plating layer on the wiring pattern so as to expose terminal portions.

8. The process according to claim 7, wherein the metal plating layer formed on the wiring pattern contains a noble metal.

9. The process according to claim 8, wherein the metal plating layer containing a noble metal is a gold plating layer.

10. The process according to claim 7, wherein the wiring pattern is roughened such that the metal plating layer formed on the wiring pattern has a surface roughness (Rz) in the range of 1.1 to 2.0 μm.

11. The process according to claim 7, wherein the resin protective layer is provided by applying a solder resist to the wiring pattern through the metal plating layer so as to expose terminal portions to form a solder resist layer or by attaching a resin protective sheet to the wiring pattern through the metal plating layer so as to expose terminal portions.

12. A semiconductor device comprising the printed wiring board of claim 1 and an electronic component mounted on the printed wiring board.

13. The printed wiring board according to claim 2, wherein the metal plating layer on the wiring pattern contains a noble metal.

14. A semiconductor device comprising the printed wiring board of claim 2 and an electronic component mounted on the printed wiring board.

15. A semiconductor device comprising the printed wiring board of claim 3 and an electronic component mounted on the printed wiring board.

16. A semiconductor device comprising the printed wiring board of claim 4 and an electronic component mounted on the printed wiring board.
